(19) United States
(12) Patent Application Publication
(10) Pub. No.: US 2019/0137678 A1
(43) Pub. Date: May 9, 2019

(54) ILLUMINATION ASSEMBLY PROVIDING BACKLIGHT

(71) Applicant: Innotec, Corp., Zeeland, MI (US)

(72) Inventors: Matthew S. Weeda, Hudsonville, MI (US); Michael J. Anderson, Allendale, MI (US); William C. Seabolt, Jr., Holland, MI (US); Gyula T. Tiszia, Budapest (HU); Zoltan J. Bakonyi, Budapest (HU)

(21) Appl. No.: 16/088,975

(22) PCT Filed: Mar. 29, 2017
(86) PCT No.: PCT/US17/24681

§ 371 Date: Sep. 27, 2018

Related U.S. Application Data
(60) Provisional application No. 62/316,970, filed on Apr. 1, 2016.

(51) Int. Cl. F21V 8/00

(52) U.S. Cl. CPC G02B 6/0021; G09F 13/04; G02B 6/0055; G02B 6/0051

(57) ABSTRACT

An illumination assembly for backlighting a decorative material includes a light pipe and a light engine. A coupling hole is formed in the light pipe and includes an inlet opening configured to receive light emitted by the light engine. The coupling hole has a central axis that extends perpendicular to a light outlet of the light engine. Light emitted by the light engine enters the coupling hole through the inlet opening and then enters the light pipe. The light is distributed through the light pipe and emitted through a light outlet for backlighting the decorative material.

### BACKGROUND OF THE INVENTION

The present invention relates to illumination assemblies, and more particularly to illumination assemblies for use in illuminating signs.

Decorative materials, such as those used in forming signs having text and/or graphics, are often illuminated by backlighting to enhance the design and/or draw attention to the materials. Examples of decorative materials used in these backlit designs include plastic films or paint. Many of these decorative materials appear to be opaque without backlighting, but can appear to “shine” or “glow” when backlit. The decorative materials are typically not completely transparent and as a result can require a significant amount of light in order to achieve the desired level and uniformity of backlight illumination.

The conventional way to backlight these decorative materials is to position multiple light sources, such as light emitting diodes (LEDs), behind the materials such that the emitted light is directed at the material. This conventional design can often result in bright spots in the backlit material corresponding to the location above each light source, which is not aesthetically desirable. One manner of addressing these bright spots is to print one or more layers of a light diffusing ink adjacent the decorative material to block the bright spots. However, this approach can reduce the overall efficiency of the optical system. In addition, printing can be difficult on many 3-dimensional surfaces and some materials cannot be printed on.

### SUMMARY

The aforementioned problems are overcome in the present invention in which an illumination assembly includes a light pipe configured to uniformly backlight a decorative material, and in particular those materials which appear opaque when unlit.

According to an embodiment, an illumination assembly includes a light pipe including a first portion including a light outlet and a second portion, opposite the first portion. The first and second portions define a body therebetween. A coupling hole is formed in the body and includes an opening in the second portion. The body can form a wall that defines an interior of the coupling hole and includes a light inlet. The coupling hole includes a central axis extending between the first and second portions, with the opening extending perpendicular to the central axis. A light engine is at least partially aligned with the opening and is adapted to direct light into the coupling hole. The light engine can include a light outlet disposed perpendicular to the central axis of the coupling hole. The light emitted by the light engine can enter the coupling hole through the opening and then enter the body through the light inlet. The light that enters through the light inlet is propagated through the body, away from the coupling hole, and is emitted through the light outlet in the first portion.

These and other advantages and features of the invention will be more fully understood and appreciated by reference to the description of the current embodiments and the drawings.

### BRIEF DESCRIPTION OF THE DRAWINGS

FIG. 1 is a perspective, partially cut-away view of an illumination assembly according to an embodiment of the invention;

FIG. 2 is an exploded view of the illumination assembly of FIG. 1;

FIG. 3 is a cross-sectional view of the illumination assembly of FIG. 1;

FIG. 4 is a cross-sectional view of a portion of an illumination assembly according to an embodiment of the invention;

FIG. 5 is a cross-sectional view of a portion of an illumination assembly according to an embodiment of the invention;

FIG. 6 is a top-down view of a portion of an illumination assembly according to an embodiment of the invention;

FIG. 7 is a top-down view of a portion of an illumination assembly according to an embodiment of the invention;

FIG. 8 is a graph illustrating coupling efficiency with respect to a ratio of coupling hole diameter to coupling hole height;

FIG. 9 is a cross-sectional view of a portion of a light pipe according to an embodiment of the invention;

FIG. 10 is a graph of illustrating coupling hole wall critical angle with respect to a refractive index of a material forming a light pipe;

FIG. 11 is a cross-sectional view of a portion of a light pipe according to an embodiment of the invention;

FIG. 12 is a cross-sectional view of a portion of a light pipe according to an embodiment of the invention;

FIG. 13 is a cross-sectional view of a portion of a light pipe according to an embodiment of the invention; and

FIG. 14 is a cross-sectional view of a lens for coupling a light engine with a light pipe according to an embodiment of the invention.

### DESCRIPTION

### I. Structure

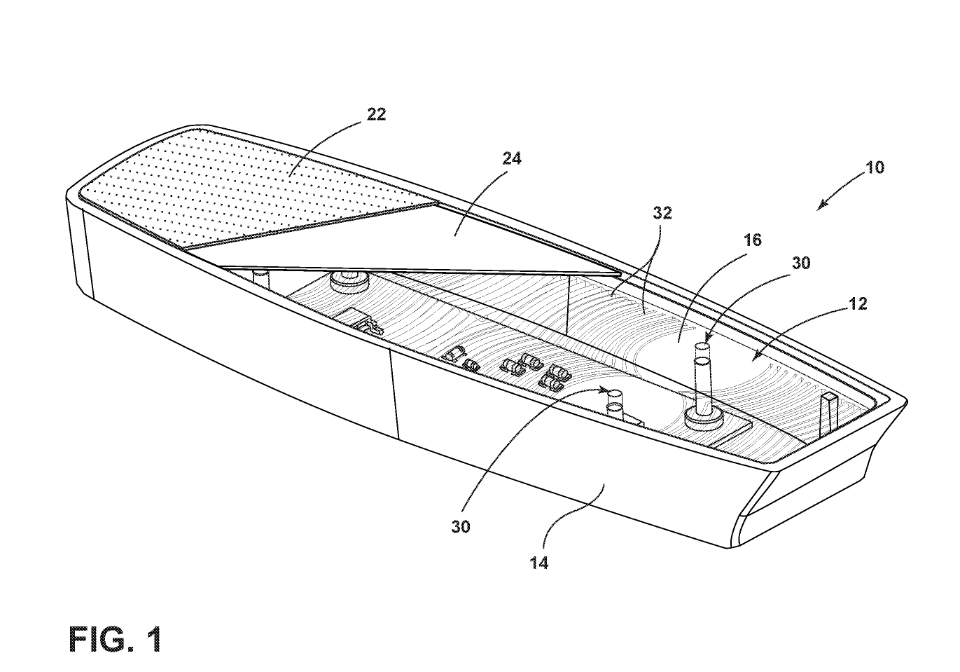

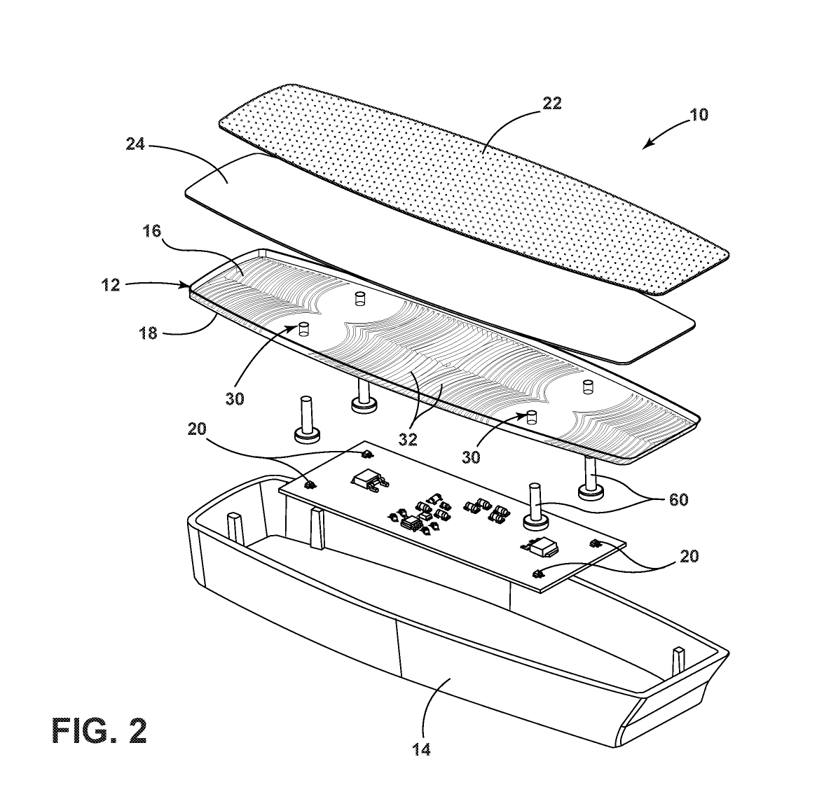

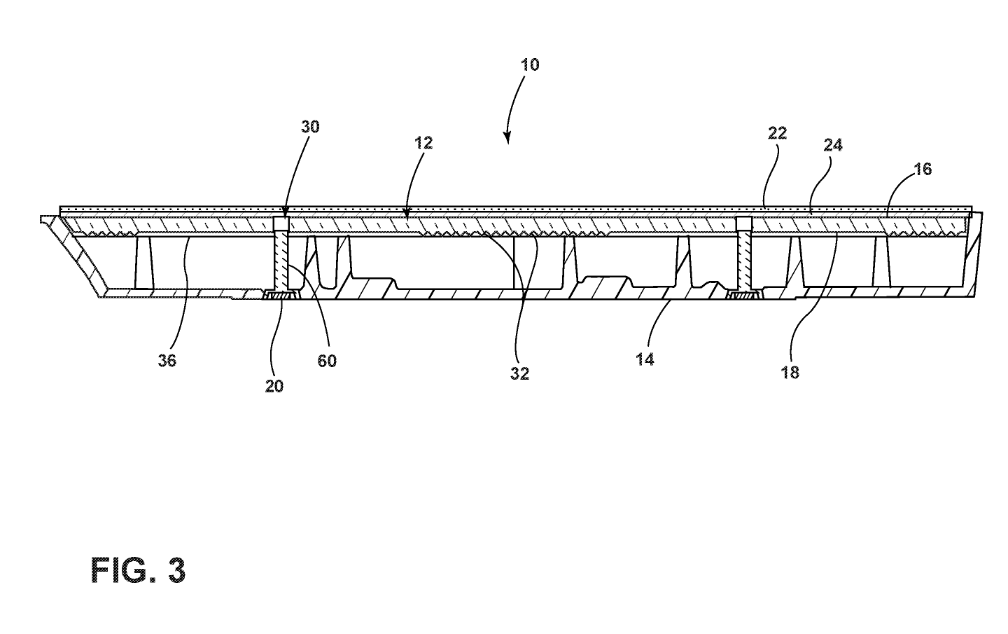

With reference to FIGS. 1-3, an illumination assembly 10 is illustrated in accordance with a first embodiment of the invention. The illumination assembly 10 can include a light guide or pipe 12 supported and at least partially encompassed by a frame 14. The light pipe 12 includes a first or outer surface 16 and an opposing second or inner surface 18. The illumination assembly 10 includes at least one light engine 20 that is coupled with the lens 60 for providing illumination to the light pipe 12. A decorative layer 22 is disposed adjacent the outer surface 16 of the light pipe 12 and is adapted to be backlit by light emitted from the light pipe 12. The decorative layer 22 can include any desired graphic, non-limiting examples of which include text, images, and combinations thereof. An optional diffusing layer 24 can be provided between the decorative layer 22 and the light pipe 12. While the illumination assembly 10 is illustrated as having a rectangular shape, it is understood that the assembly 10 can have any desired geometric shape without deviating from the scope of the invention.

This specification consistently uses the term “light pipe” to refer to the portion 12. The terms “light guide” or “wave guide” could be used interchangeably with “light pipe”. Light pipe in this specification is intended to include any device designed to transport light from a light source to a location at some distance from the light source with minimal, or at least modest, loss. Light is transmitted through a light pipe by means of total internal reflection.

Still referring to FIGS. 1-3, the frame 14 can be used to at least partially frame the light pipe 12, decorative layer 22, and optional diffusing layer 24, as well as mount the light engines 20. In addition to framing the assembly 10 and optionally holding the light engines 20 in place relative to the light pipe 12, the frame 14 can also provide additional features, such as acting as a heat sink for the light engines 20 and supporting the various other components of the assembly 10, such as a circuit board or a power source.

The decorative layer 22 can be in the form of a film or panel and optionally having graphics adhered, etched, printed, painted and/or engraved thereon. The decorative layer 22 and the frame 14 can be configured such that the decorative layer 22 is held in place relative to the light pipe 12 by the frame 14. Alternatively, the sign 12 can be held in place using one or more mechanical fasteners (not shown). The decorative layer 22 can be made from a polymeric material, wood veneer, textile, metal, or non-metallic materials having a metallic or metallic-appearing finish. In one example, the decorative layer 22 is in the form of a single or multi-layer film or an ink or paint layer. The decorative layer 22 is optionally supported on the diffusing layer 24 or on a separate, transparent support layer.

The light pipe 12 includes a coupling hole 30 generally aligned with each light engine 20 for coupling the light emitted by the light engine 20 with the lens 60. The light pipe 12 optionally includes one or more extraction elements, such as optical aberrations 32, adapted to extract light through the outer surface 16 for backlighting the decorative layer 22. The optical aberrations may be etched, painted, engraved, embedded and/or adhered in or on the surface of the surface of the light pipe 12. The optical aberrations can be provided in patterns, non-limiting examples of which include dot patterns of offset rows, hatched circles, hatched boxes, lattice structures, chevron shapes, grooves, ribbing, and lines of varying depth. Other optical aberration patterns and configurations will be known to those skilled in the art.

The optional diffusing layer 24 can be any suitable single layer or multi-layer material for diffusing light emitted from the light outlet in the outer surface 16 of the light pipe 12. Non-limiting examples of suitable diffusing layer material includes paper, translucent acrylonitrile butadiene styrene (ABS), translucent polycarbonate (PC), translucent polyvinyl chloride (PVC), translucent acrylic, translucent polyethylene terephthalate (PET), translucent polybutylene terephthalate (PBT), translucent polypropylene, and translucent polyethylene.

The illumination assembly 10 can also include an optional backer layer 36 which is adapted to reflect light that exits through the inner surface 18 of the light pipe 12 back into the light pipe 12. The backer layer 36 can be any suitable single layer or multi-layer material for reflecting light back into the light pipe 12. Non-limiting examples of suitable backer layer materials includes paper, white ABS, white PC, white PVC, white acrylic, white PET, white PBT, white polypropylene, and white polyethylene.

The light engine 20 includes a light source adapted to emit illumination. Non-limiting examples of suitable light sources include a light emitting diode (LED), small incandescent light bulbs, electroluminescent lighting (EL), organic light emitting diodes (OLEDs), and/or other non-LED light sources. The number, spacing, voltage, current, intensity, and color of the light sources can be selected depending on the configuration of the illumination assembly 10 and the intended use.

The light engine 20 can include electronic components for controlling the electrical current through the light source. The light engine 20 may also contain electronic devices and circuitry to communicate with other light engines or devices in a system. This enables the light engine 20 to operate dynamically, that is, where color and brightness of the light changes over time to create a dynamic lighting experience. Multiple light engines 20 can be controlled together as part of a system to create moving and changing lighting effects. The light engine 20 may also include or provide for communication, either wired or wireless, to external devices such as personal cell phones, automotive body electronic control modules, or similar devices. This enables relatively easy customization and/or integrates the system with its surrounding environment and/or application.

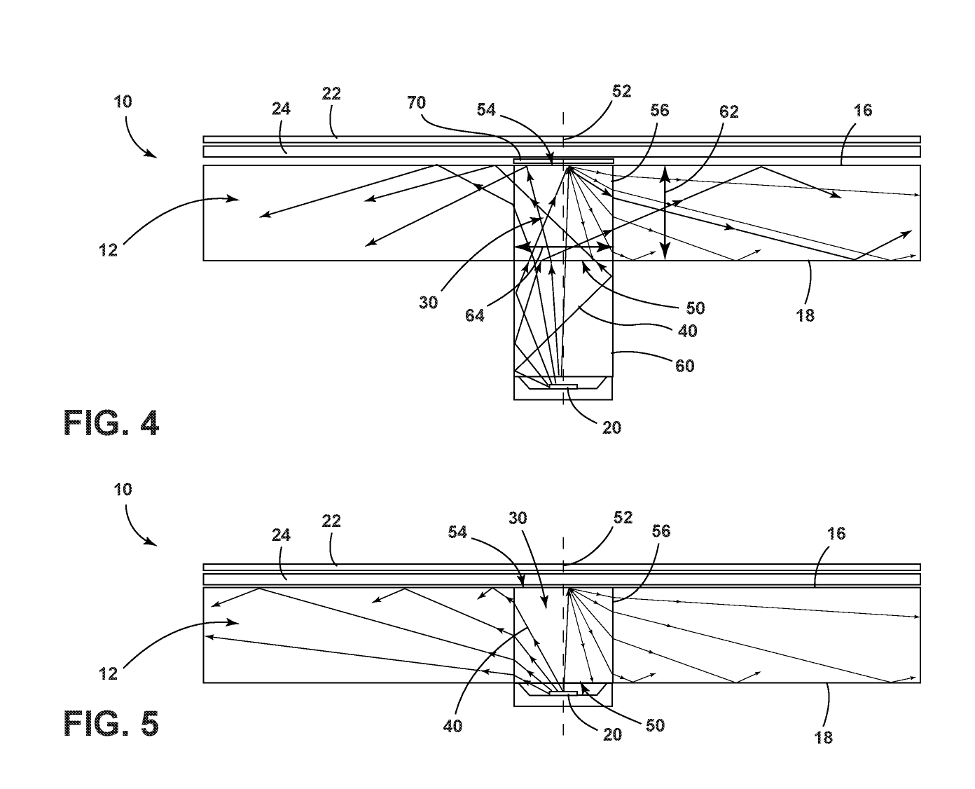

Referring now to FIGS. 4 and 5, the coupling of the light engine 20 and the light pipe 12 is further described. FIG. 4 is a schematic representation of a portion of the illumination assembly 10 including the light pipe 12, the light engine 20, the decorative layer 22, the diffusing layer 24 and the lens 60. A plurality of light rays 40 are shown to illustrate some of the transmission of light through the light pipe 12. These light rays are provided for illustrative purposes only for the purposes of discussion and should not be interpreted as a representation of the actual transmission of light through the light pipe 12 or all of the emitted and extracted light.

The coupling hole 30 is incorporated into the light pipe 12 for coupling the light rays 40 emitted by the light engine 20 into the light pipe 12 for distribution of the light rays 40 radially through the light pipe 12. The coupling hole 30 includes a first or inlet opening 50 that extends perpendicular to a central axis 52 of the coupling hole 30. The coupling hole 30 optionally includes a second or outlet opening 54 opposite the inlet opening 50, along the central axis 52. The coupling hole 30 is defined by a wall 56 that is formed by the internal surfaces of the light pipe 12. The wall 56 includes a light inlet which allows light that enters the coupling hole 30 through the inlet opening 50 to enter the light pipe 12.

The light engine 20 can be coupled with the inlet opening 50 of the coupling hole 30 by a lens 60, as illustrated in FIG. 4. Alternatively, the light engine 20 can be coupled directly with the inlet opening 50, without the use of a lens, as illustrated in FIG. 5. When the size and configuration of the illumination assembly 10 allows, the light engine 20 can be positioned immediately adjacent the inlet opening 50 such that light emitted by the light engine 20 is directed into the coupling hole 30 without the aid of a lens. The lens 60 can be used to couple the light emitted from the light engine 20 with the coupling hole 30 when the configuration of the light assembly 10, such as the 3-dimensional shape of the light pipe 12 or the position of other components, inhibits positioning the light engine 20 immediately adjacent the inlet opening 50. There may also be a small air gap between the light engine 20 and the lens 60 or the inlet opening 50.

Still referring to FIG. 4, the coupling hole 30 can have a height 62 and a diameter or width 64. The coupling hole height 62 is defined as a distance between the inlet opening 50 and the outlet opening 54 along the central axis 52. The coupling hole width 64 is defined as a distance between opposing surfaces defining the wall 56 along an axis perpendicular to the central axis 52. The coupling hole 30 may be a circular hole that is symmetrical about the central axis 52 such that the width 64 corresponds to the diameter of the coupling hole 30. Alternatively, the coupling hole 30 may be radially asymmetrical such that the width 64 is not symmetrical about the central axis 52. For example, the coupling hole 30 may be in the form of an ellipse or an oval. The coupling hole 30 can have any regular or irregular geometric shape to provide the desired coupling of light into the light pipe 12. The width 64 can be constant along the central axis 52, as illustrated in FIGS. 4 and 5, or vary along the central axis 52.

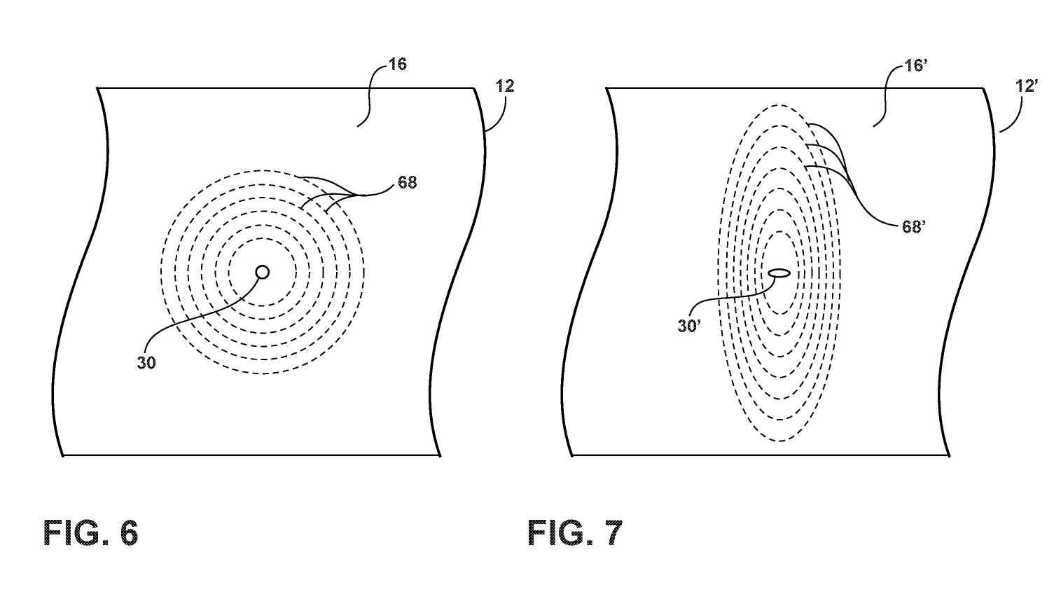

With reference now to FIGS. 6 and 7, the shape of the coupling hole 30 can be configured to direct light in a particular direction within the light pipe 12. For example, as illustrated in FIG. 6, when the coupling hole 30 is a circular hole, symmetrical about the central axis, light is coupled into the light pipe 12 with generally the same intensity in all directions within the plane of the light pipe 12, as illustrated by circles 68. Alternatively, the coupling hole 30 can be configured to couple light into the light pipe 12 such that the distribution of light varies within the plane of the light pipe 12. For example, as illustrated in FIG. 7, the coupling hole 30′ can be configured as an ellipse such that the distribution of light 68′ within the plane of the light pipe 12′ is elliptical or otherwise varies compared to the circular coupling hole 30.

### II. Operation

Referring again to FIG. 4, the illumination assembly 10 can be used to backlight the decorative layer 22. The light pipe 12 utilizes total internal reflection (TIR) to guide and distribute the light rays 40 radially through the light pipe 12 to facilitate uniformly backlighting the decorative layer 22.

The lens 60 directs the light rays 40 emitted by the light engine 20 to the coupling hole inlet opening 50. At least a portion of the light rays 40 entering the coupling hole 30 hit the wall 56 defining the coupling hole 30 and are refracted into the light pipe 12. A portion of the light rays 40 that enter the light pipe 12 are trapped between the outer and inner surfaces 16 and 18 until they are extracted through the light outlet in the outer surface 16 where the extracted light backlights the decorative layer 22. Another portion of the light rays 40 may be extracted through the inner surface 18. The light extracted through the inner surface 18 can be reflected back into the light pipe 12 by the backer layer 36, where the light continues to scatter and refract through the light pipe 12. Another portion of the light rays 40 may hit the distal ends of the light pipe 12 and be refracted back into the light pipe 12 or leak out of the assembly 10.

Still referring to FIG. 4, a portion of the light directed into the coupling hole 30 by the lens 60 does not directly hit the coupling hole wall 56 and instead exits the coupling hole 30 through the outlet opening 54. In one example, the diffusing layer 24 includes a reflective cover 70 on a portion of the undersurface thereof, adjacent the outlet opening 54, that is configured to reflect the light exiting through the outlet opening 54 back into the coupling hole 30. At least a portion of the reflect light will enter the light pipe 12 through the coupling hole wall 56 and a portion will hit the light engine 20 where it will be reflected back into the coupling hole 30 and so forth.

The reflective cover 70 adjacent the outlet opening 54 can be adhered or painted onto the undersurface of the diffusing layer 24 or may be provided as a separate component from the diffusing layer 24. The reflective component 70 is preferably opaque, but in some embodiments may allow some light to pass through. In one example, the reflective cover 70 is in the form of a reflective paint applied over the outlet opening 54. When the reflective cover 70 is carried by the diffusing layer 24, the reflective cover 70 is only located adjacent the outlet opening 54 such that light extracted through the light outlet in the outer surface 16 is capable of entering the diffusing the layer 24. In general, when the illumination assembly 10 includes a reflective cover 70 for reflecting light that exits through the outlet opening 54, the reflective cover 70 is limited to covering the outlet opening 54 such that the light extracted through the light outlet in the outer surface 16 of the light pipe 12 is capable of backlighting the decorative material 22. In some embodiments, the outlet opening 54 is not covered by a reflective cover 70.

Positioning the light engine 20 along the central axis 52 of the coupling hole 30 such that the light engine 20 is positioned perpendicular to the central axis 52 facilitates coupling the emitted light with the light pipe 12 for distribution away from the coupling hole 30 and through the body of the light pipe 12. The angle of the coupling hole walls and the refractive index of the material forming the light pipe 12 can be selected such that light rays that directly hit the coupling hole walls 56 are immediately coupled into the light pipe 12 for distribution through the light pipe by total internal reflection (TIR). The configuration of the coupling hole 30 is also designed such that at least a portion of the light rays that do not enter the light pipe 12 through the coupling hole walls 56 on the first pass are recycled such that they are coupled into the light pipe 12 on a subsequent pass.

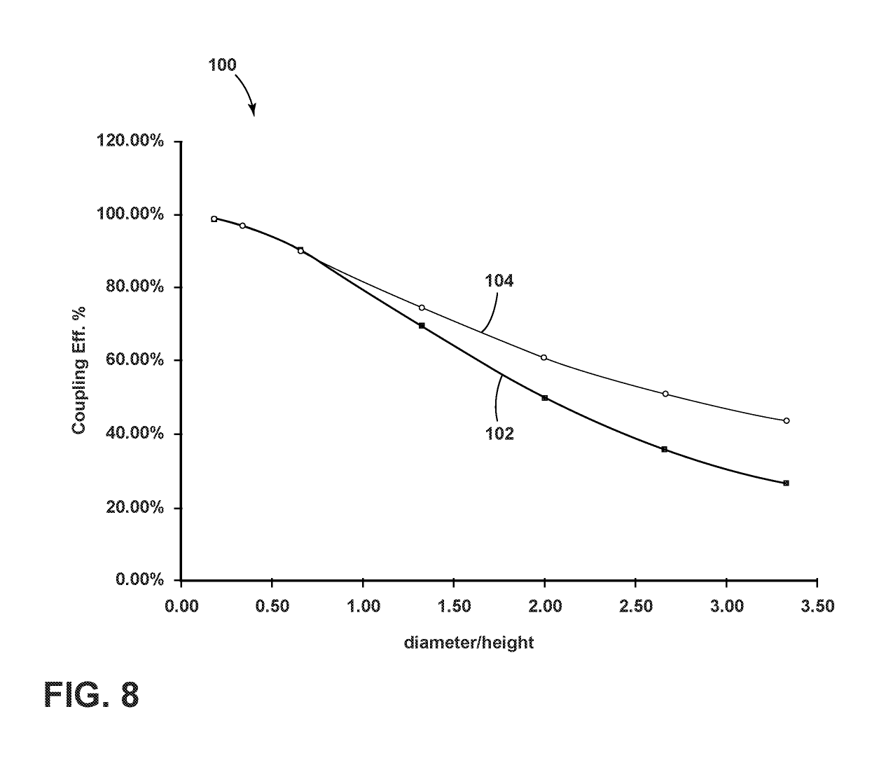

Referring now to FIG. 8, the effect of the configuration of the light engine 20 and the coupling hole 30 on the coupling efficiency of the light emitted by the light engine 20 and the light pipe 12 is illustrated. The data in graph 100 was obtained using ray trace simulations in OpticStudio 16.5. The simulation assumes that the light pipe is disc shaped and includes a cylindrical coupling hole at the center of the disc having a predetermined diameter and height and no reflective cover on the hole outlet. The disc material in the simulations was assumed to be 100% transparent. The coupling efficiency was calculated as the ratio of the luminous flux exiting on the side surface of the disc divided by the light input. Curve 102 illustrates the relationship between coupling efficiency and the ratio of hole diameter to hole height when the light source is assumed to be a point source in which the light rays originate from a center point of the light source. Curve 104 illustrates the relationship between coupling efficiency and the ratio of hole diameter to hole height when the light source is an extended light source in which the illumination is assumed to be evenly distributed across the surface area of the light source. The extended light source is configured to cover the entire diameter of the coupling hole. For both the point source and the extended source light sources, the angular distribution of the light is assumed to be Lambertian.

The data illustrated in FIG. 8 demonstrates how the configuration of the coupling hole 30 can be varied to provide the desired coupling efficiency of light emitted by the light engine 20 with the light pipe 12. As illustrated by curves 102 and 104, when the ratio of the coupling hole diameter to height is less than 1, the light coupling efficiency is greater than 80% and can even be as high as 90% or greater. In practice, the light source is likely to have a light emission profile that is between that of a point source and an extended source. Thus, the data illustrated by curves 102 and 104 demonstrates that coupling efficiency may also be effected by coordinating the size of the emitting surface of the light engine 20 with the diameter of the coupling hole 30. The data illustrated by curves 102 and 104 also demonstrate that a significant amount of light can be coupled into the light pipe 12 even without a reflective cover on the outlet opening 54 of the coupling hole 30.

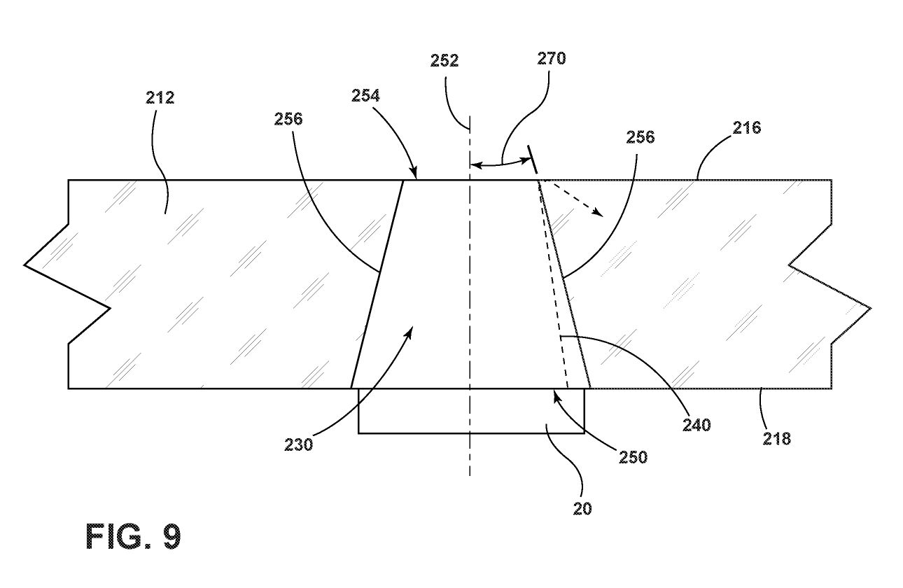

FIG. 9 illustrates a light pipe 212 that is similar to the light pipe 12 of FIGS. 1-4 except for the configuration of the coupling hole 230. Therefore, elements of the light pipe 212 similar to those of the light pipe 12 are labeled with the prefix 200. The light pipe 212 can be used with the illumination assembly 10 of FIGS. 1-4 in a manner similar to that described above for the light pipe 12 to backlight the decorative layer 22.

As illustrated in FIG. 9, the coupling hole wall 256 can extend at an angle 270 relative to the central axis 252 between the outer and inner surfaces 216, 218. At least a portion of the light rays 240 entering the coupling hole 230 hit the wall 256 defining the coupling hole 230 and are refracted into the light pipe 212 in a manner similar to that described above for the light pipe 12. The angle 270 of the wall 256 can be less than or equal to 90 degrees. The angle 270 of the wall 256 may be constant such that the coupling hole 230 is symmetrical about the central axis 252. Alternatively, the angle 270 can vary such that the coupling hole 230 is asymmetrical about the central axis 252.

When the angle 270 is less than 90 degrees, as illustrated in FIG. 9, the outlet opening 254 has a smaller width than the width of the inlet opening 250. In some configurations, the width of the outlet opening 254 may be small enough such that a sufficient amount of light is coupled into the light pipe 212 without covering the outlet opening 254 with the reflective cover 70 described above with respect to FIG. 4. Optionally, the outlet opening 254 may be covered by a reflective cover that (specularly or not) reflects light exiting the coupling hole 230 through the outlet opening 254 back into the coupling hole 230.

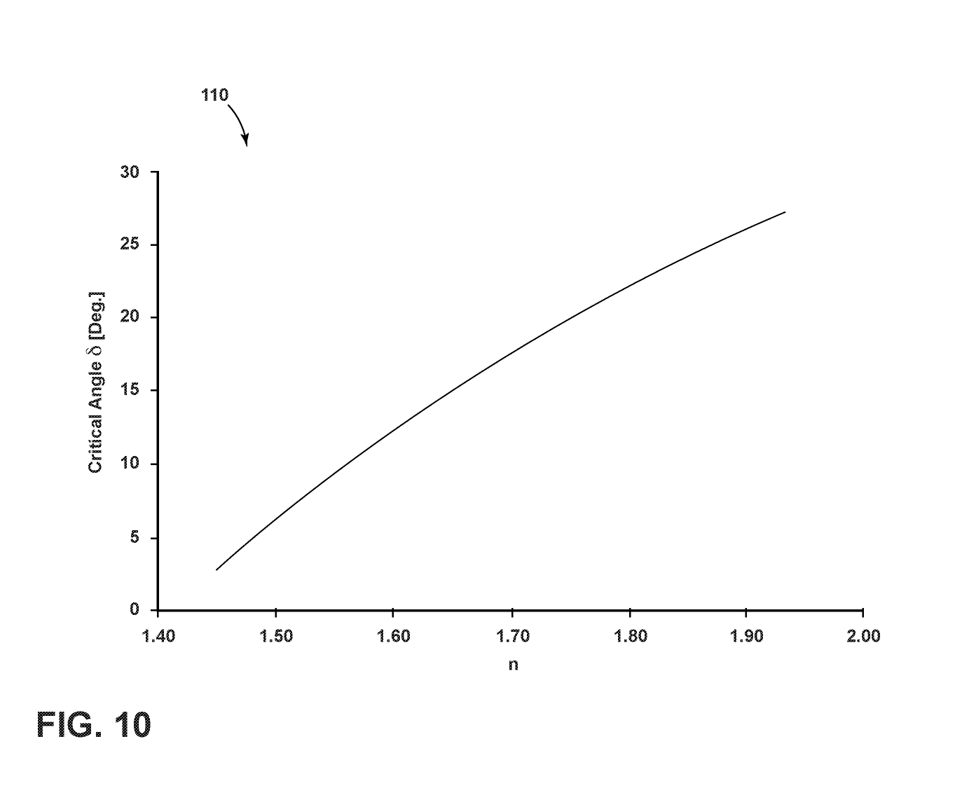

Referring now to FIG. 10, graph 110 illustrates the relationship between the angle 270 of the coupling hole wall 256 and the index of refraction of the material forming the light pipe 212. The data in graph 110 was obtained using ray trace simulations in OpticStudio 16.5. The simulation assumes that the light pipe is disc shaped and includes a coupling hole at the center of the disc having a predetermined diameter and height and does not include a reflective cover over the outlet opening. The critical angle δ corresponds to the angle of the coupling hole wall 256 below which any light rays hitting the wall 256 will be coupled into the light pipe 212. Thus, as illustrated in FIG. 10, the angle 270 of the coupling hole wall 256 can be selected based on the index of refraction of the material forming the light pipe 212 to provide the desired light coupling characteristics. For a given index of refraction, if the angle 270 of the coupling hole wall 256 is less than the critical angle δ, then any light rays hitting the wall 256 will be coupled into the light pipe 212.

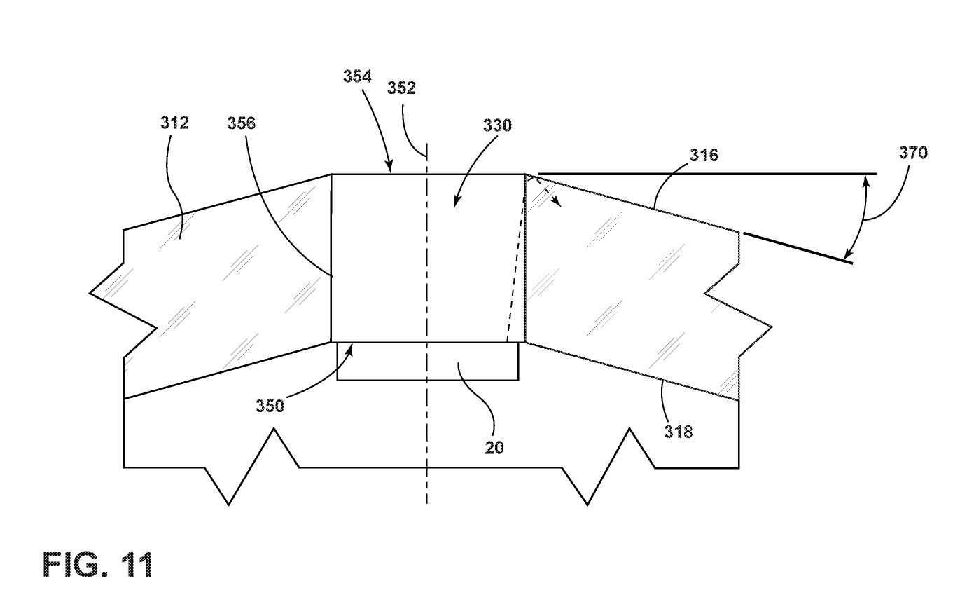

FIG. 11 illustrates a light pipe 312 that is similar to the light pipe 12 of FIGS. 1-4 except for the shape of the light pipe 312. Therefore, elements of the light pipe 312 similar to those of the light pipe 12 are labeled with the prefix 300. The light pipe 312 can be used with the illumination assembly 10 of FIGS. 1-4 in a manner similar to that described above for the light pipe 12 to backlight the decorative layer 22.

FIG. 11 illustrates an embodiment in which the coupling hole 330 and light engine 20 can be used with a light pipe 312 that is not planar. As illustrated, the outer surface 316 extends at an angle 370 relative to the central axis 352 of the coupling hole 330. The inner surface 318 can extend at a similar angle relative to the central axis 352 such that the outer surface 316 and the inner surface 318 are generally parallel. The coupling hole walls 356 can extend parallel to the central axis 352, as illustrated, or extend at an angle less than 90 degrees with respect to the central axis 352, such as illustrated in the embodiment of FIG. 9. At least a portion of the light emitted by the light engine 20 hits the coupling hole walls 356 and is coupled into the light pipe 312. Light that is coupled into the light pipe 312 is distributed through the light pipe 312 by TIR and can be extracted through the light outlet in the outer surface 316 for backlighting a decorative layer (not shown) in a manner similar to that described above with respect to FIGS. 4 and 5.

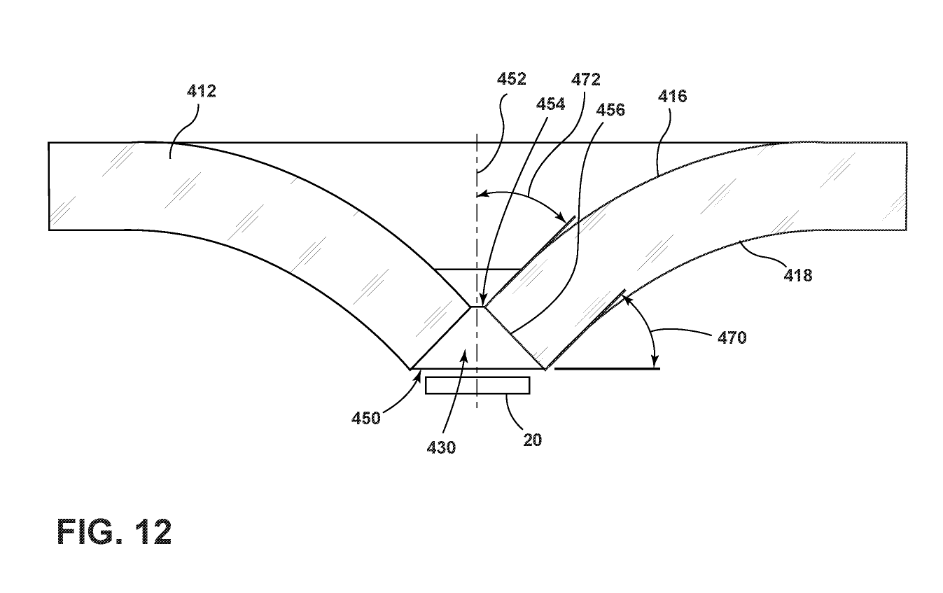

FIG. 12 illustrates a light pipe 412 that is similar to the light pipe 12 of FIGS. 1-4 except for the shape of the light pipe 412 and the configuration of the coupling hole 430. Therefore, elements of the light pipe 412 similar to those of the light pipe 12 are labeled with the prefix 400. The light pipe 412 can be used with the illumination assembly 10 of FIGS. 1-4 in a manner similar to that described above for the light pipe 12 to backlight the decorative layer 22.

FIG. 12 illustrates an embodiment in which the coupling hole 430 and light engine 20 can be used with a light pipe 412 having curved surfaces. As illustrated, the inner surface 418 and the outer surface 416 extend away from the coupling hole 430 at an angle 470 and 472, respectively, relative to the central axis 452. The angles 470 and 472 may be 90 degrees or less and may be the same or different. In contrast to the embodiment of FIG. 11 in which the outer and inner surfaces 316 and 318 are linear, the outer and inner surfaces 416 and 418 of the embodiment of FIG. 12 can be curved.

The coupling hole walls 456 can extend at an angle to the central axis 452 that is less than 90 degrees such that the diameter of the outlet opening 454 is less than the diameter of the inlet opening 450. At least a portion of the light emitted by the light engine 20 hits the coupling hole walls 456 and is coupled into the light pipe 412. Light that is coupled into the light pipe 412 is distributed through the light pipe 412 by TIR and can be extracted through the light outlet in the outer surface 416 for backlighting a decorative layer (not shown) in a manner similar to that described above with respect to FIG. 4.

As discussed above with respect to the embodiment of FIG. 4, the outlet opening 54 of the coupling hole 30 in the light pipe 12 may be covered with a reflective cover 70 that reflects light exiting through the outlet opening 54 back into the coupling hole 30 to increase the coupling efficiency of the coupling hole 30. With regards to the embodiment of FIG. 12, because the outlet opening 454 is smaller than the inlet opening 450, the coupling efficiency of the light emitted by the light engine 20 may be sufficient such that it is not necessary to cover the outlet opening 454 with a reflective cover. However, the outlet opening 454 may be covered with a reflective cover, in a manner similar to the embodiment of FIG. 4, to provide the desired coupling efficiency.

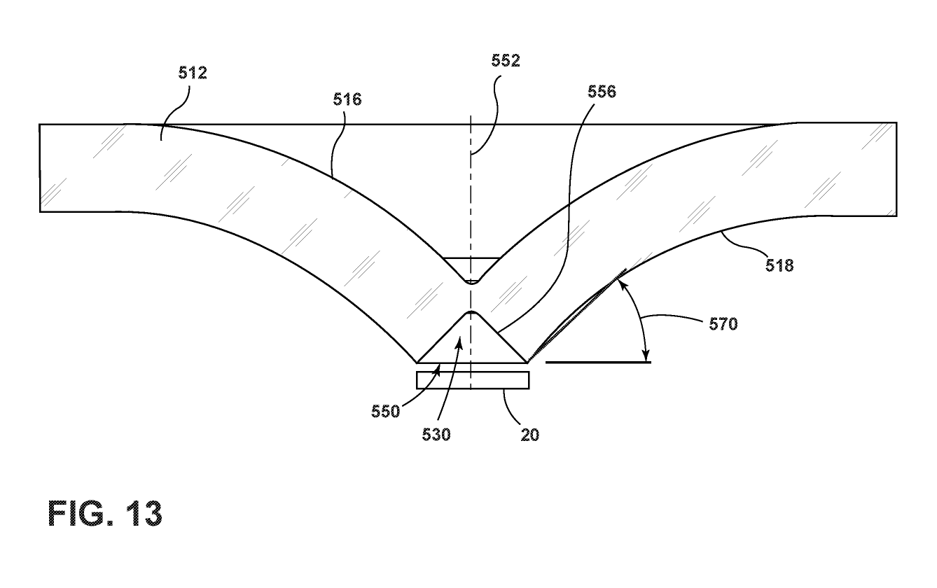

FIG. 13 illustrates a light pipe 512 that is similar to the light pipe 412 of FIG. 12 except for the configuration of the coupling hole 530. Therefore, elements of the light pipe 512 similar to those of the light pipe 412 are labeled with the prefix 500. FIG. 13 illustrates an embodiment in which the coupling hole 530 does not extend through the entire body of the light pipe 512 between the inner surface 518 and the outer surface 516. At least a portion of the light emitted by the light engine 20 hits the coupling hole walls 556 and is coupled into the light pipe 512. Light that is coupled into the light pipe 512 is distributed through the light pipe 512 by TIR and can be extracted through the light outlet in the outer surface 516 for backlighting a decorative layer (not shown) in a manner similar to that described above with respect to FIGS. 4 and 5.

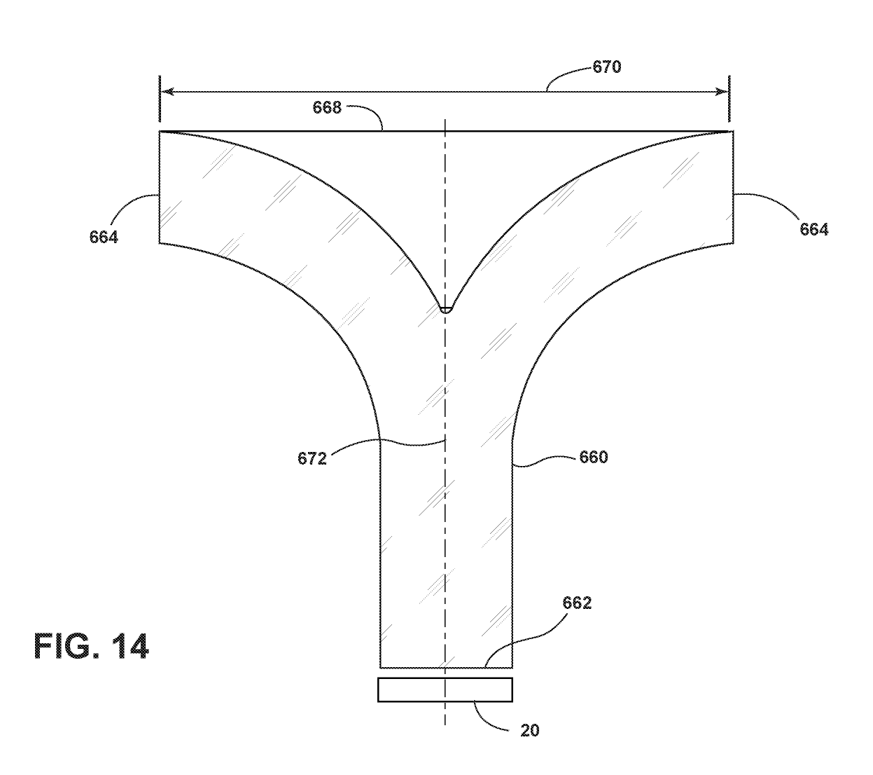

FIG. 14 illustrates an alternative lens 660 that can be used in place of the lens 60 illustrated in FIG. 4 for coupling light with the light pipe 12 when the light engine 20 is spaced from the inlet opening 50. The lens 660 includes a lens inlet 662 that is adapted to receive light emitted by the light engine 20 for transmission through the lens 660. The lens 660 includes a lens outlet 664 that is adapted to emit the light transmitted through the lens 660. The lens outlet 664 defines an outlet end 668 of the lens 660 having a diameter 670 that is smaller than the coupling hole 30 into which the lens 660 is adapted to be inserted.

The outlet end 668 can be inserted into the coupling hole 30 such that the lens outlet 664 is generally aligned with the coupling hole wall 56. Light emitted by the light engine 20 travels through the lens 660 where it is emitted through the lens outlet 664. At least a portion of the light emitted through the lens outlet 664 hits the coupling hole wall 56 and is coupled into the light pipe 12 for distribution through the light pipe 12. The dimensions of the coupling hole 30, the angle of the coupling hole wall 56 with respect to the central axis 52, and/or the angle of the lens outlet 664 with respect to a central axis 672 of the lens 660, can be selected to provide the desired coupling efficiency between the light emitted by the light engine 20 and the light pipe 12.

The lens 660 can be provided as a separate component for coupling light from the light engine 20 into the light pipe 12. In some embodiments, the lens 660 may be integrally formed with the light pipe 12.

### III. Conclusion

The illumination assemblies described herein couple light emitted by multiple light sources into the light pipe such that the light can be distributed through the light pipe for backlighting a decorative material. Conventional designs for backlighting decorative materials rely on placing multiple light sources, such as LEDs, behind the decorative material such that the emitted light is directed at the decorative material. However, this configuration often results in non-uniform backlighting of the decorative material, including bright spots above each light source.

The illumination assemblies described herein provide a coupling hole within the light pipe which can be used to couple light emitted by a light source into the light pipe such that the light can be distributed away from the light source and through the light pipe. The light that is coupled into the light pipe through the coupling hole can be distributed away from the coupling hole and the light source through the light pipe for extraction through the light outlets formed in the light pipe. Spreading the light away from each individual light source can provide more uniform backlighting of the adjacent decorative material. Distributing the light more uniformly through the light pipe minimizes the appearance of undesirable bright spots in the decorative material and may provide sufficient backlighting with fewer light sources, thus increasing the efficiency of the illumination assembly.

The coupling hole described herein can be configured for use with planar light pipes as well as light pipes having a curved and/or 3-dimensional shape. The coupling hole can also be configured for use with materials having a range of different indices of refraction. The coupling hole can be used to couple light into the light pipe when the light engine is positioned adjacent the inlet opening or spaced from the inlet opening through a suitable lens. In this manner the coupling hole provides for increased flexibility in designing an illumination assembly for uniformly backlighting a decorative material.

The illumination assemblies described herein position the light source relative to the coupling hole such that the emission surface or light outlet of the light source is perpendicular to the central axis of the coupling hole. The configuration of the coupling hole, the light pipe material, and/or the configuration of the light pipe can be adjusted to provide the desired light coupling between the light emitted by the light source and the light pipe. For example, the dimensions of the coupling hole and/or the angle of the coupling hole walls can be adjusted to control the light coupling efficiency of the coupling hole based on the material of the light pipe and/or the configuration of the light pipe, such as whether the light pipe is planar or curved. Additional features, such as a reflective cover over the outlet opening of the coupling hole can be used to control the light coupling efficiency of the coupling hole. The coupling hole and light engine configurations described herein can be used to couple light into a light pipe for backlighting assemblies having a variety of different shapes, sizes, and materials.

The above description is that of current embodiments of the invention. Various alterations and changes can be made without departing from the spirit and broader aspects of the invention as defined in the appended claims, which are to be interpreted in accordance with the principles of patent law including the doctrine of equivalents. To the extent not already described, the different features and structures of the various embodiments of the light pipes 12, 12′, 212, 312, 412, and 512 and coupling holes 30, 30′, 230, 330, 430, and 530 may be used in combination with each other as desired. That one feature may not be illustrated in all of the embodiments is not meant to be construed that it cannot be, but is done for brevity of description. Thus, the various features of the different embodiments of the light pipes 12, 12′, 212, 312, 412, and 512 and coupling holes 30, 30′, 230, 330, 430, and 530 may be mixed and matched as desired to form new embodiments, whether or not the new embodiments are expressly disclosed.

This disclosure should not be interpreted as an exhaustive description of all embodiments of the invention or to limit the scope of the claims to the specific elements illustrated or described in connection with these embodiments. For example, and without limitation, any individual element of the described invention may be replaced by one or more alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative.

The invention is not limited to the details of operation or to the details of construction and the arrangement of the components set forth in the above description or illustrated in the drawings. The invention may be implemented in various other embodiments and practiced or carried out in alternative ways not expressly disclosed herein.

The phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

The disclosed embodiment includes a plurality of features that are described in concert and that might cooperatively provide a collection of benefits. The present invention is not limited to only those embodiments that include all of these features or that provide all of the stated benefits.

Any reference to claim elements in the singular, for example, using the articles “a,” “an,” “the” or “said,” is not to be construed as limiting the element to the singular.

Directional terms, such as “front,” “back,” “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation.

1. An illumination assembly comprising:
a light pipe including a first portion providing a light outlet and a second portion opposite the first portion, the first and second portions defining a body therebetween, the body defining a coupling hole having an inlet opening in the second portion and an outlet opening in the first portion, the body including a wall defining an interior of the coupling hole the coupling hole having a central axis extending between the first and second portions;
a light engine at least partially aligned with the inlet opening to direct light into the coupling hole; and
a reflective component covering the outlet opening to reflect light exiting the outlet opening through the outlet opening back into the coupling hole, wherein light emitted by the light engine enters the coupling hole through the inlet opening and then at least one of (a) enters the body through the coupling hole wall to propagate through the body, away from the coupling hole, and to be emitted through the light outlet in the first portion and (b) is reflected by the reflective component back into the coupling hole.

2. The illumination assembly of claim 1 wherein the wall extends at an angle with respect to the central axis that is less than 90 degrees.

3. The illumination assembly of claim 1 wherein at least one of the first portion and the second portion extends at an angle with respect to the central axis that is less than or equal to 90 degrees.

4. The illumination assembly of claim 3 wherein:
the body is made from a material having an index of refraction, and
wherein the angle is based on the index of refraction of the material forming the body.

5. The illumination assembly of claim 1 wherein the outlet opening in the first portion has a diameter that is smaller than a diameter of the inlet opening in the second portion.

6. The illumination assembly of claim 1 comprising at least one extraction element for extracting at least a portion of the light propagating within the body through the light outlet in the first portion.

7. The illumination assembly of claim 1 comprising a diffuser layer adjacent the light outlet in the first portion for distributing the light emitted through the light outlet.

8. The illumination assembly of claim 7 wherein the diffuser layer comprises at least one of paper, translucent ABS, translucent PC, translucent PVC, translucent acrylic, translucent PET, translucent PBT, translucent polypropylene, and translucent polyethylene.

9. The illumination assembly of claim 1 wherein the reflective component is opaque.

10. The illumination assembly of claim 1 wherein the coupling hole is one of circular, oval, and elliptical.

11. The illumination assembly of claim 1 wherein:
the coupling hole opening has a diameter and the coupling hole extends into the body a predetermined depth, and
wherein a ratio of the opening diameter to the depth of the coupling hole is selected to provide a coupling efficiency of at least 80%.

12. The illumination assembly of claim 1 comprising a sign having a graphic disposed adjacent the light outlet, whereby light emitted through the light outlet backlights the graphic.

13. The illumination assembly of claim 1 further comprising a lens coupling the light engine with the coupling hole.

14. The illumination assembly of claim 13 wherein the lens has a central axis aligned with the central axis of the coupling hole.

15. The illumination assembly of claim 14 wherein the lens has a lens light outlet aligned with the inlet opening.

16. The illumination assembly of claim 15 wherein the lens light outlet is integrally formed with the body.

17. The illumination assembly of claim 1 wherein the reflective component allows some light to pass therethrough.

18. The illumination assembly of claim 1 wherein the reflective component comprises a reflective paint.

19. The illumination assembly of claim 1 wherein the reflective component is limited to covering the outlet opening.

20. An illumination assembly comprising:
a light pipe including a first portion including a light outlet and a second portion, opposite the first portion, the first and second portions defining a body therebetween, the body made from a material having an index of refraction;
a coupling hole formed in the body and having an opening in the second portion, the body forming a wall defining an interior of the coupling hole and including a light inlet, the coupling hole having a central axis extending between the first and second portions, wherein the opening extends perpendicular to the central axis, at least one of the first portion and the second portion extending at an angle with respect to the central axis that is less than or equal to 90 degrees, wherein the angle is based on the index of refraction of the material forming the body; and
a light engine at least partially aligned with the opening and adapted to direct light into the coupling hole, the light engine having a light outlet disposed perpendicular to the central axis of the coupling hole,
wherein the light emitted by the light engine enters the coupling hole through the opening and then enters the body through the light inlet, and
wherein the light that enters through the light inlet propagates through the body, away from the coupling hole, and is emitted through the light outlet in the first portion.

21. An illumination assembly comprising:
a light pipe including a first portion including a light outlet and a second portion, opposite the first portion, the first and second portions defining a body therebetween;
a coupling hole formed in the body and having an opening in the second portion, the body forming a wall defining an interior of the coupling hole and including a light inlet, the coupling hole having a central axis extending between the first and second portions, wherein the opening extends perpendicular to the central axis, the coupling hole opening having a diameter, the coupling hole extending into the body a predetermined depth, a ratio of the opening diameter to the depth of the coupling hole selected to provide a coupling efficiency of at least 80%; and
a light engine at least partially aligned with the opening and adapted to direct light into the coupling hole, the light engine having a light outlet disposed perpendicular to the central axis of the coupling hole,
wherein the light emitted by the light engine enters the coupling hole through the opening and then enters the body through the light inlet, and
wherein the light that enters through the light inlet propagates through the body, away from the coupling hole, and is emitted through the light outlet in the first portion.

22. An illumination assembly comprising:
a light pipe including a first portion including a light outlet and a second portion, opposite the first portion, the first and second portions defining a body therebetween;
a coupling hole formed in the body and having an opening in the second portion, the body forming a wall defining an interior of the coupling hole and including a light inlet, the coupling hole having a central axis extending between the first and second portions, wherein the opening extends perpendicular to the central axis; and
a light engine at least partially aligned with the opening and adapted to direct light into the coupling hole, the light engine having a light outlet disposed perpendicular to the central axis of the coupling hole, the light engine coupled with the coupling hole by a lens, whereby light emitted by the light engine is directed toward the coupling hole opening through the lens, the lens including a lens light inlet having a central axis aligned with the central axis of the coupling hole, the lens including a lens light outlet aligned with the light inlet formed by the wall of the coupling hole, whereby light emitted through the lens light outlet enters the body through the light inlet,
wherein the light emitted by the light engine enters the coupling hole through the opening and then enters the body through the light inlet, and
wherein the light that enters through the light inlet propagates through the body, away from the coupling hole, and is emitted through the light outlet in the first portion.

23. The illumination assembly of claim 22 wherein the lens light outlet is integrally formed with the body.
